(19) United States
(12) Patent Application Publication
(10) Pub. No.: US 2026/0350455 A1
(43) Pub. Date: Nov. 5, 2026

(54) LEARNING-BASED METHOD FOR NOISE-ERROR MITIGATION, COMPUTING SYSTEM AND COMPUTER PROGRAM PRODUCT

(71) Applicant: IQM FINLAND OY, Espoo (FI)

(72) Inventors: Amin HOSSEINKHANI, Munich (DE); Alessio CALZONA, Munich (DE); Adrian AUER, Munich (DE); Ines DE VEGA, Munich (DE)

(21) Appl. No.: 19/485,843

(22) PCT Filed: May 19, 2023
(86) PCT No.: PCT/EP2023/063517

§ 371 Date: Nov. 19, 2025

(51) Int. Cl. G06N 10/70

(52) U.S. Cl. CPC G06N 10/70

(57) ABSTRACT

The present invention is related to a method for mitigating errors caused by noise in an execution of a target quantum circuit T by a quantum processor, said method being a learning-based method using at least one training quantum circuit to gain knowledge about the noise in the execution of a target quantum circuit by the quantum processor. The invention is further related to a computing system configured to carry out said method, to a computer program product and to a computer-readable data carrier.

The present invention is related to a learning-based method for noise error mitigation. The present invention is further related to a computing system, a computer program product and a computer-readable data carrier for carrying out said method.

An important problem in the noisy intermediate scale quantum (NISQ) era is to estimate the value of an observable as the output of a quantum circuit executed by a quantum processor. Due to the noise present in the execution of the circuit, the estimator value is usually biased. One potential way to overcome this problem is quantum error correction. However, in the NISQ era this approach is generally not possible for large scale problems due to hardware noise and a lack of a sufficient number of qubits.

One currently available solution is quantum error mitigation (QEM). This solution is based on algorithmic schemes that reduce the noise-induced bias in the expectation value by post-processing outputs from a plurality of quantum circuit runs using particularly chosen circuits at different noise levels. An overview of current quantum error mitigation techniques may be found in “Hybrid quantum-classical algorithms and quantum error mitigation” by S. Endo et.al., arXiv: 2011.01382v1 and “Quantum error mitigation” by Z. Cai et.al., arXiv: 2210.00921V1.

A central feature that distinguishes different error mitigation techniques is whether a precise knowledge of the noise in the hardware is required or not. While a precise knowledge of the noise may in principle allow for perfect compensation of the errors, the error model must in general be determined through some form of tomography. This may be difficult or even impossible in practice. An alternative approach are learning-based quantum error mitigation techniques, where expectation values estimated with so-called training quantum circuits are used to obtain information about the noise profile of the quantum processor and to use this knowledge to mitigate noise in the execution of a target quantum circuit by the same quantum processor. The training circuits are chosen such that they are similar to the target quantum circuit, usually in terms of circuit structures, so that they contain similar circuit faults as the target quantum circuit. Furthermore, the training circuits are chosen to be classically simulable, that is the expectation values may be obtained efficiently via simulation on a classical computer.

One example of learning-based quantum error mitigation is disclosed in “Error mitigation with Clifford quantum circuit data” by P. Czarnik et al., Quantum 5,592 (2021). There, a set of training quantum circuits composed largely of Clifford gates and being related to the target circuit is defined. For example, a subset of non-Clifford gates in the target circuit is replaced by Clifford gates that are close in distance to the original gates to construct the training circuits. Then, each of said training quantum circuits is executed on a classical computer, respectively on a quantum computer, to thereby infer an exact value, respectively a noisy value, of an estimator of the expectation value of an observable O. A model for the noise-free value of the observable for the target quantum circuit is constructed from the noisy expectation values and parameters for the model are determined by regression or machine learning methods.

EP 4 036 816 A1 is directed to a solution where so-called fermionic linear optics (FLO) circuits are chosen as the training quantum circuits for learning-based quantum error mitigation. Such an approach is particularly well-suited to simulate a fermionic system.

Another approach based on training quantum circuits which are Clifford circuits is disclosed in “Learning-based quantum error mitigation” by A. Strikis et al., arXiv: 2005. 07601v2. Instead of directly learning the ideal measurement outcomes from noisy ones, this work introduces a learning-based method for realizing quasi-probability error mitigation without depending on process tomography.

All learning-based QEM techniques have in common, that they require the evaluation of the training quantum circuits on the quantum computer and/or the classical computer. Provided that the training quantum circuits and the target quantum circuit are affected by the noise in a sufficiently similar way, the knowledge obtained via the execution of the training quantum circuit can then be used to mitigate the effect of the noise on the target quantum circuit. Thus, the choice of the training quantum circuits is clearly a crucial element for a successful implementation of learning-based techniques.

So far, however, there is no well-defined protocol that can assess how well noise affecting a given training quantum circuit does mimic the noise on the target quantum circuit. Presently, the choice of the training quantum circuits is based on the vague and lose requirement that the training quantum circuits share a similar circuit structure with the target quantum circuit. This represents a fundamental block for the development of learning-based techniques, whose performance varies currently uncontrollably depending on the choice of a specific set of target quantum circuits.

In light of the problems in the prior art, it is thus the goal of the present invention to provide a learning-based error mitigation method that includes the selection of a set of training quantum circuits which result in a high-performance learning-based quantum error mitigation technique.

According to a first aspect of the present invention, there is provided a method for mitigating errors caused by noise in an execution of a target quantum circuit T by a quantum processor, said method being a learning-based method using at least one training quantum circuit to gain knowledge about the noise in the execution of the target quantum circuit by the quantum processor, said method comprising:
i) deriving at least one auxiliary quantum circuit Aₐ, a=1, . . . , M, M≥1 from said target quantum circuit T, wherein each auxiliary quantum circuit is efficiently classically simulable;
ii) selecting a plurality of N execution strategies Sᵢ, i=1, . . . , N for the quantum circuits, each execution strategy corresponding to an execution of the quantum circuit with an associated value λᵢ≥1 of a noise strength λ;
iii) for each execution strategy Sᵢ, executing the target quantum circuit and each of the M auxiliary quantum circuits Aₐ on the quantum processor according to said execution strategy Sᵢ to thereby obtain a target estimator value E_{O}(T, Sᵢ) of an expectation value of an observable O, said target estimator value E_{O}(T, Sᵢ) being associated with the target quantum circuit T and the execution strategy Sᵢ, and an auxiliary estimator value E_{O}(Aₐ, Sᵢ) of the expectation value of the observable O, said auxiliary estimator value E_{O}(Aₐ, Sᵢ) being associated with the auxiliary quantum circuit Aₐ and the execution strategy S;
iv) for each auxiliary quantum circuit Aₐ, calculating, by a classical computer, a value vₐ of a figure of merit D which is a function of at least the target estimator values E_{O}(T, Sᵢ) and the auxiliary estimator values E_{O}(Aₐ, Sᵢ) associated with said auxiliary quantum circuit Aₐ for each of the N execution strategies Sᵢ, i=1, . . . , N, wherein the figure of merit D is such that its value is minimal when the dependence of the target estimator values E_{O}(T, Sᵢ) and the auxiliary estimator values E_{O}(Aₐ, Sᵢ) on the execution strategies Sᵢ is similar;
v) selecting 1≤k≤M auxiliary quantum circuits Aₐ for which the value vₐ of the figure of merit D fulfills a validation criterion as the training quantum circuits for the learning-based error mitigation method.

A quantum circuit may comprise instructions related to a number of n qubits, a certain initial state of said n qubits, an application of a unitary transformation by an application of a predetermined gate sequence of quantum gates, each quantum gate preferably acting on a small number of qubits of the n qubits, each quantum gate being preferably a single-qubit gate or a two-qubit gate, and a measurement of an observable O of the final state of the n qubits after the application of the gate sequence. A quantum circuit may be understood as an implementation of a quantum algorithm.

The quantum processor comprises a register of n qubits, means for applying quantum gates, preferably means for applying single-qubit gates and two-qubit gates, and measurement means for measuring the observable O of the state of the n qubits. In one example, the observable O may be measured by measuring each of the n qubits in the computational basis.

The execution of the quantum circuit by the quantum processor comprises preparing the n qubits in the qubit register in the initial state according to the instructions of the quantum circuit, applying the unitary transformation by an application of an execution gate sequence according to the instructions of the quantum circuit (i.e., on the basis of the predetermined gate sequence) and the execution strategy by the means for applying quantum gates and measuring the final state of the n qubits obtained after the application of the unitary transformation with the measurement means according to the instructions of the quantum circuit to thereby measure a value of the observable O. Due to the probabilistic nature of quantum mechanics, the quantum circuit is repeatedly executed many times (many shots) to thereby obtain an estimator value of the expectation value of the observable. I.e., when the final state of the quantum circuit is described by a density operator ρ, the expectation value of the observable O with associated hermitian operator Ô is given by tr[ρÔ]. When the outcome of the measurement of the observable O for the j-th execution of the quantum circuit (j-th shot) is Oⱼ, the expectation value may be approximated by an estimator value which is a function of the measurement outcomes Oⱼ. In one example, the estimator may be the mean, and the estimator value may be the mean value of the observable, i.e.,

$$\frac{1}{N} {\sum }_{j = 1}^{N} {O}_{j}$$

wherein N is the number of shots.

The estimator value of the observable associated with a quantum circuit Q=T or Q=Aₐ, and the execution strategy Sᵢ is denoted by E_{O}(Q, Sᵢ). As the execution strategy Sᵢ is associated with a value λᵢ of the noise strength, one may also write E_{O}(Q, Sᵢ)=E_{O}(Q, λᵢ). I.e., the estimator value depends on the value λᵢ of the noise strength.

The target quantum circuit T is a quantum circuit of interest, and the target estimator value of the expectation value of the observable O may be related to the solution of a computational problem. Thus, the goal of QEM is to obtain an approximation of the target estimator value in the zero-noise limit, E_{O}(T, λ=0). The target quantum circuit comprises instructions for realizing a target unitary transformation by a predetermined target gate sequence. The auxiliary quantum circuit comprises instructions for realizing an auxiliary unitary transformation by a predetermined auxiliary gate sequence.

According to the method of the present invention, the quantum circuits are executed according to an execution strategy associated with a value λᵢ noise strength λ. An execution strategy specifies how the unitary transformation of the quantum circuit is realized by the quantum processor, e.g., by modifying the predetermined gate sequence of the quantum circuit while still realizing the same unitary transformation and/or by modifying the implementation of the quantum gates, e.g., by different gate application times. In the absence of noise (λ=0), the execution strategy would have no influence on the outcome of the computation, as in theory each execution strategy results in the realization of the same unitary transformation of the qubits of the register, transforming their state from the initial state to the final state. However, in NISQ quantum processors, the execution of a quantum circuit is inevitably noisy. The different execution strategies introduce different amounts of noise in the execution of the quantum circuit by the quantum processor as quantified by the value λᵢ of the noise strength λ, e.g., due to a different number of executed quantum gates. The noise strength λ is a dimensionless parameter. The value λᵢ of the noise strength associated with a certain execution strategy may be assigned by a user of the method based on well-thought considerations. For example, different execution strategies may comprise changing physical parameters when implementing the quantum gates by the quantum processor or by inserting a sequence of abundant gates in the predetermined gate sequence of the quantum circuit, said sequence of abundant quantum gates being equivalent to the identity if operated noiselessly. Concrete examples of different execution strategies and their associated value λᵢ of the noise strength will be presented below.

In one example, the execution strategies may be selected by a user of the method and provided to the classical computer and/or the quantum processor. In another example, said execution strategies may be selected by the classical computer, e.g., on the basis of a user input, e.g, on the basis of a desired value of the noise strength.

In one example, there may be an intrinsic or optimal execution strategy of the target quantum circuit by the quantum processor for which it is expected that the error of the estimator value of the expectation value of the observable O is minimal. For example, this optimal/intrinsic execution strategy may be obtained for a special realization of the unitary transformation of the quantum circuit by an execution of a particular gate sequence, e.g. a special sequence of one- and two qubit gates, wherein each quantum gate is implemented in an optimal way on the quantum processor. For the target quantum circuit, this special gate sequence may be the target gate sequence, and for the auxiliary quantum circuit, this special gate sequence may be the auxiliary gate sequence. Further, the application time for the quantum gates may be optimized for this optimal execution strategy. This optimal/intrinsic execution strategy may be associated with a value of λ₁=1 of the noise strength. Then, every other execution strategy is not the optimal one, and is associated with a noise strength λᵢ>1. Thus, different execution strategies may comprise different realizations of the unitary transformation of the quantum circuit. For example, if the optimal/intrinsic execution strategy with value λ₁=1 is by an application of the target gate sequence, execution strategies with a value of λᵢ>1 may comprise inserting gate sequences in the target gate sequence which are equal to the identity in the zero-noise limit. Additionally or alternatively, the quantum gates may be realized differently by the quantum processor, e.g., via different gate times.

Executing the target quantum circuit and each auxiliary quantum circuit according to each of a plurality of execution strategies to thereby obtain a target estimator value and an auxiliary estimator value for each execution strategy Sᵢ is known in the art. It is well-known that quantifying λᵢ for a given execution strategy, while physically motivated, may have an inevitable uncertainty, resulting in an uncertainty of the noise-mitigated target estimator value.

The at least one auxiliary quantum circuit is preferably derived from the target quantum circuit such that the target quantum circuit and the auxiliary quantum circuit have a similar circuit structure. Deriving the auxiliary quantum circuit may comprise inserting and/or replacing quantum gates in the target gate sequence of the target quantum circuit and/or removing quantum gates from the target gate sequence of the target quantum circuit to thereby obtain the auxiliary gate sequence of the auxiliary quantum circuit. For example, deriving the at least one auxiliary quantum circuit may comprise deriving an auxiliary quantum circuit which has the same sequence of two qubit gates, in particular the same sequence of CNOT-gates as the target quantum circuit. However, the invention is not limited to this. In principle any quantum circuit acting on the same number of qubits and measuring the same observable O as the target quantum circuit may be chosen as the auxiliary quantum circuit. However, not all auxiliary quantum circuits are equally well-suited to learn about the noise in the execution of the target quantum circuit as their behavior under noise may be completely different. The method according to the present invention provides an objective quantification of the ability of an auxiliary quantum circuit to mimic the noise of the target circuit. Possible embodiments for deriving auxiliary quantum circuits will be described below.

In one example, said deriving of said at least one auxiliary quantum circuit may be performed by or assisted by the classical computer. Additionally, or alternatively, said deriving of said at least one auxiliary quantum circuit may be performed by the user of the method. The user may then provide information defining the auxiliary quantum circuits to the classical computer and/or the quantum processor.

The auxiliary quantum circuits are efficiently classically simulable. I.e., they may be simulated in a time which is polynomial in the number n of qubits on a classical computer.

According to the method of the present invention, a number k of auxiliary quantum circuits Aₐ, a=1, . . . , M, M≥1 is selected as the training quantum circuits for the learning-based error mitigation method for which the value vₐ of the figure of merit D fulfills a validation criterion, wherein 1≤k≤M. I.e., at least one auxiliary quantum circuit is selected as the training quantum circuit. The figure of merit D is such that its value is minimal when the dependence of the target estimator values E_{O}(T, Sᵢ) and the auxiliary estimator values E_{O}(Aₐ, Sᵢ) on the execution strategies Sᵢ/the value λᵢ of the noise strength, is similar. That is, the value of the figure of merit D is minimal when the dependence of the target and auxiliary estimator values on the execution strategies Sᵢ matches. Preferably, the figure of merit D is such that its value is minimal when the dependence of the target estimator values and the auxiliary estimator values on the execution strategies Sᵢ is identical. The target estimator values and the auxiliary estimator values may have the same or a similar dependence on the noise strength λ. I.e. when E_{O}(T, Sᵢ)=f(λᵢ) and E_{O}(Aₐ, Sᵢ)=g(λᵢ) for real-valued functions f and g, the figure of merit may be minimal when for each auxiliary quantum circuit Aₐ the ratio E_{O}(T, Sᵢ)/E_{O}(Aₐ, Sᵢ)=cₐ(1+ϵ_{a,i}) for the N different execution strategies Sᵢ, wherein cₐ is a constant for the quantum circuit Aₐ and ϵ_{a,i} is a small variation (and a real number). Preferably, |ϵ_{a,i}|≤0.1, more preferably |ϵ_{a,i}|≤0.05 and even more preferably |ϵ_{a,i}|≤0.01. Even more preferably, the figure of merit D may be minimal when for at least one, and preferably for all quantum circuits Aₐ, ϵ_{a,i}=0 for all execution strategies Sᵢ. In one example, the figure of merit D is minimal when cₐ=c for all auxiliary quantum circuits Aₐ. Said selecting of said auxiliary quantum circuits as the training quantum circuit(s) may be performed by or assisted by the classical computer in one example.

As the figure of merit D quantifies the similarity of the noise dependence of the auxiliary quantum circuits and the target quantum circuit, the method according to the present invention provides an objective criterion for selecting training quantum circuits that are best suited for the learning-based error mitigation method from a set of auxiliary quantum circuits. The choice of the validation criterion allows to select at least one auxiliary quantum circuit as the training quantum circuit for the learning-based method.

In a preferred embodiment, the value vₐ may fulfill the validation criterion when vₐ is at most a validation threshold value, the validation threshold value being preferably one of the values vₐ of the figure of merit D for the M auxiliary quantum circuits. Preferably, the validation threshold value may be the smallest value vₐ of the M values of the figure of merit D. Then, only one auxiliary quantum circuit is selected as the training quantum circuit for the learning-based error mitigation method. This auxiliary quantum circuit has the property that among all auxiliary quantum circuits its noise dependence is closest to the noise dependence of the target quantum circuit. When the validation criterion is fulfilled when vₐ is at most a validation threshold value, more than one auxiliary quantum circuit Aₐ may be selected as the training quantum circuit for the learning-based error mitigation method. In one example, one may select the m auxiliary quantum circuits with the m lowest values vₐ of the figure of merit D as the training quantum circuits for the learning-based error mitigation method.

In one embodiment, the method may be such that for each auxiliary quantum circuit Aₐ, the figure of merit D is proportional to a measure of dispersion of the ratios of the target estimator values E_{O}(T, Sᵢ) and the auxiliary estimator values E_{O}(Aₐ, Sᵢ) for each execution strategy Sᵢ, D (Aₐ)=D(E_{O}(T, S₁)/E_{O}(Aₐ, Sᵢ), . . . , E_{O}(T, S_{N})/E_{O}(Aₐ, S_{N})). I.e., vₐ=D(E_{O}(T, S₁)/E_{O}(Aₐ, S₁), . . . , E_{O}(T, S_{N})/E_{O}(Aₐ, S_{N})). Said function may have a minimum when all ratios are equal or approximately equal, i.e., when the target quantum circuit and the auxiliary quantum circuits have the same or approximately the same noise dependence. The measure of dispersion may be the variance, the standard deviation or the mean absolute difference, but it is not limited to this.

In a preferred embodiment, the figure of merit D is a function of the absolute values of the differences between the ratios of the target estimator values E_{O}(T, Sᵢ), E_{O}(T, Sⱼ) and the auxiliary estimator values E_{O}(Aₐ, Sᵢ), E_{O}(Aₐ, Sᵢ) for pairwise different execution strategies Sᵢ, Sⱼ. I.e., D is a function of E_{O}(T,Sᵢ)/E_{O}(Aₐ,Sᵢ)−E_{O}(T,Sⱼ)/E_{O}(Aₐ,Sⱼ). Preferably

$$D ( {A}_{a} ) ∝ {\sum }_{i \neq j = 1}^{N} {C}_{ij} * \vert {E}_{O} ( T , {S}_{i} ) / {E}_{O} ( {A}_{a} , {S}_{i} ) - {E}_{O} ( T , {S}_{j} ) / {E}_{O} ( {A}_{a} , {S}_{j} ) \vert ,$$

wherein Cᵢⱼ are real numbers. I.e., vₐ=D(Aₐ). In one example,

$${C}_{ij} = C = \frac{{E}_{O} ( {A}_{a} , 0 )}{N} .$$

Here the nominator is the noise-free expectation value of the observable O associated with the auxiliary circuit Aₐ. It may be assumed that this expectation value is not zero. I.e., if this turns out to be zero, one may discard that specific auxiliary quantum circuit and select another auxiliary quantum circuit. The denominator is the number of execution strategies, N. In one example,

$$D ( {A}_{a} ) = {\sum }_{i \neq j = 1}^{N} {C}_{ij} * \vert {E}_{o} ( T , {S}_{i} ) / {E}_{o} ( {A}_{a} , {S}_{i} ) - {E}_{o} ( T , {S}_{j} ) / {E}_{o} ( {A}_{a} , {S}_{j} ) \vert .$$

In principle, the auxiliary quantum circuits may be arbitrarily derived from said target quantum circuit T as long as they involve the same number of qubits and the measurement of the same observable O. In a preferred embodiment, the target quantum circuit T may comprise a target gate sequence with a first quantum gate, said first quantum gate acting on at least one qubit, and wherein deriving at least one of said auxiliary circuits Aₐ from said target quantum circuit T may comprise replacing said first quantum gate by a replacement gate thereby obtaining an auxiliary gate sequence, said replacement gate acting preferably on the same qubits as the first quantum gate. I.e., when the first quantum gate is a p-qubit gate (e.g. 1-qubit gate) acting on the p qubits q₁ . . . , qₚ, the replacement gate is preferably a p-qubit gate acting on the same p qubits q₁ . . . , qₚ. In one embodiment, several quantum gates, i.e., 2, 3 or more quantum gates of the target gate sequence may each be replaced by a particular replacement gate to thereby obtain the auxiliary gate sequence.

Preferably, said first quantum gate may comprise a non-Clifford gate, and said replacement gate may comprise a Clifford gate. In one embodiment, all non-Clifford gates may be replaced by a replacement gate comprising a Clifford gate. In one embodiment, the replacement gate may be a Clifford gate. In a further embodiment, the replacement gate may be a Clifford gate which is the closest Clifford gate to said first quantum gate.

Alternatively, an angle of said Clifford gate may be randomly selected. The angle θ_{C} of the Clifford gate may be randomly selected from a set of all Clifford angles, i.e

$${θ}_{C} ϵ \{ 0 , \frac{π}{2} , π , \frac{3 π}{2} \} ,$$

based on a user-defined distribution. An example of user-defined distribution is:

e^{-∇θ}^{²}^{/σ}^{²}

in which ∇θ is the difference between the non-Clifford angle of the first quantum gate and the set of Clifford angles θ_{C}, and the width σ is arbitrarily defined by a user of the method. In the special case where σ=0, using this distribution is equivalent to using the closest Clifford gate for the replacement.

If all quantum gates of the target gate sequence are replaced by Clifford gates, the derived auxiliary quantum circuit is classically simulable. However, there are also other possibilities to derive a classically simulable auxiliary quantum circuit from the target quantum circuit.

In one embodiment, the target gate sequence may comprise a plurality of non-Clifford gates, and wherein deriving at least one of said auxiliary quantum circuits from said target quantum circuit T comprises replacing each non-Clifford gate of a first number of the non-Clifford gates by a Clifford gate and keeping each non-Clifford gate of a second number of the non-Clifford gates. The first number and/or the second number may be non-zero in one example. I.e., the auxiliary gate sequence comprises at least the first number of Clifford gates and the second number of non-Clifford gates. In a preferred example, the auxiliary gate sequence differs from the target gate sequence only in that each of the non-Clifford gates of the first number of non-Clifford gates is replaced by a Clifford gate. Preferably, the second number is small so that efficient classical simulation of the respective auxiliary quantum circuit is feasible with a classical computer. Preferably, the second number is at most 15, preferably at most 10, even more preferably at most 5. The second number may be selected by a user of the method. In one example, it may be determined randomly, e.g., by the classical computer, which non-Clifford gates are kept.

In a further embodiment, the target gate sequence may comprise a third quantum gate, and deriving at least one of said auxiliary quantum circuits from the target quantum circuit may comprise removing the third quantum gate. For example, one auxiliary quantum circuit may be derived from the target quantum circuit by removing all single-qubit gates from the target gate sequence.

In one embodiment, a first execution strategy Sᵢ associated with a first value λᵢ of the noise strength λ comprises an implementation of a second quantum gate of said gate sequence by an application of a control pulse C during an application time r by said quantum processor, and wherein a second execution strategy Sⱼ associated with a second value λⱼ of the noise strength λ which is larger than the first value of the noise strength, λⱼ>λᵢ, comprises an implementation of the second quantum gate by an application of a recalibrated control pulse C′ for a stretched application time τ′=τ·λⱼ/λᵢ by said quantum processor. The gate sequence is the target gate sequence for the target quantum circuit and it is the auxiliary gate sequence for the auxiliary quantum circuit. In this way, the same execution strategy is used for the target quantum circuit and the auxiliary quantum circuit.

In one embodiment, the first execution strategy Sᵢ associated with the first value λᵢ of noise strength λ may comprise an implementation of each quantum gate Gₖ of said gate sequence by an application of a control pulse Cᵢ during an application time τᵢ by said quantum processor, and the second execution strategy associated with a second value λⱼ of the noise strength λ which is larger than the first value of the noise strength λⱼ>λᵢ may comprise an implementation of each quantum gate Gᵢ of the gate sequence by an application of a recalibrated control pulse Cⱼ′ for a stretched application time τⱼ′=τᵢ·λⱼ/λᵢ by said quantum processor. Different execution strategies are thus realized by a pulse level control. The gate sequence is the target gate sequence for the target quantum circuit and it is the auxiliary gate sequence for the auxiliary quantum circuit. In this way, the same execution strategy is used for the target quantum circuit and the auxiliary quantum circuit.

In a further embodiment, a third execution strategy may comprise adding an additional gate sequence corresponding to an identity operation to said gate sequence, wherein preferably the additional gate sequence corresponds to a product of a unitary operation Uᵢ and its hermitian conjugate

$${U}_{i}^{†} ,$$

wherein the unitary operation or its hermitian conjugate corresponds to at least one gate of said gate sequence. The additional gate sequence may be added before or after, preferably directly before or directly after, the at least one gate in one example. The gate sequence is the target gate sequence for the target quantum circuit and it is the auxiliary gate sequence for the auxiliary quantum circuit. In this way, the same execution strategy is used for the target quantum circuit and the auxiliary quantum circuit.

In one embodiment, the unitary operation or its hermitian conjugate may correspond to all quantum gates of the gate sequence of the target and auxiliary quantum circuits, respectively. In one embodiment, the additional gate sequence may correspond to a plurality of products of unitary operations U; and the corresponding hermitian conjugate

$${U}_{i}^{†} ,$$

wherein each unitary Uᵢ or its hermitian conjugate corresponds to at least one gate of the target and the auxiliary gate sequences, respectively. In one embodiment the additional gate sequence may be the complete gate sequence of the quantum circuit. For example, if the gate sequence of the quantum circuit is represented by the unitary U and is associated with a value \tilde{λ} of the noise strength λ, then an execution strategy with the noise strength \tilde{λ}ₚ=(2p+1)\tilde{λ} may be realized by an application of the unitary operation U (UU^{†})^{p} or U (U^{†}U)^{p} or (U^{†}U)^{p} U. The gate sequence is the target gate sequence for the target quantum circuit and it is the auxiliary gate sequence for the auxiliary quantum circuit. In this way, the same execution strategy is used for the target quantum circuit and the auxiliary quantum circuit.

In one further embodiment, the method may further comprise: a fourth execution strategy comprises executing said gate sequence of the quantum circuit followed by executing the inverse of said gate sequence. The gate sequence is the target gate sequence for the target quantum circuit and it is the auxiliary gate sequence for the auxiliary quantum circuit. In this way, the same execution strategy is used for the target quantum circuit and the auxiliary quantum circuit.

Thus, the execution strategies may comprise unitary folding as described, e.g. in “Digital zero noise exploitation for quantum error mitigation” by T. Giurgica-Tiron et al., 2020 IEEE International Conference on Quantum Computing and Engineering (QCE), 306. There, for a circuit composed of d unitary layers U=L_{d} . . . L₂ L₁ wherein d represents the depth of the circuit and each block Lⱼ can either represent a single layer of operation or just a single gate, “circuit folding” and “gate (or layer) folding” are described. The general circuit folding replacement rule is:

$$U \to {U}_{j} = {U ( {U}^{†} U )}^{p} {L}_{d}^{†} {L}_{d - 1}^{†} … {L}_{s}^{†} {L}_{s} … {L}_{d - 1} {L}_{d} .$$

The total number of layers of the new circuit is d(2p+1)+2s. Thus, if the original circuit is associated with a value λⱼ of the noise strength λ, the execution strategy Sⱼ which comprises the application of the gate sequence described by the unitary Uⱼ is associated with the value

$${λ}_{j} = ( 1 + \frac{2 ( p + s )}{d} ) \tilde{λ}$$

of the noise strength.
The general gate (or layer) folding replacement rule is as follows:

$$∀ j ∈ \{ 1 , 2 , … , d \} : {L}_{j} \to {{L}_{j} ( {L}_{j}^{†} {L}_{j} )}^{p} if j ∉ S ,$$

$$and {L}_{j} \to {{L}_{j} ( {L}_{j}^{†} {L}_{j} )}^{p + 1} if j ϵ S ,$$

wherein S is a subset of the full set of indices such that the number of elements in S is s=ISI. The number of gates (or layers) after the application of the gate folding rule is d (2p+1)+2s, so that this execution strategy is associated with the

$${λ}_{j} = ( 1 + \frac{2 ( p + s )}{d} ) \tilde{λ}$$

of the noise strength.

The error mitigated value of the target estimator value may be determined by known learning-based error mitigation techniques using the selected auxiliary quantum circuit(s) as the training quantum circuit(s). One example, is Clifford data regression (CDR), as disclosed for example in P. Czarnik et al., Quantum 5, 592 (2021). Alternatively, the error mitigated value of the target estimator value may be determined by variable-noise CDR as disclosed, for example, in A. Lowe et al., Physical Review Research 3, 033098 (2021).

Thus, in one embodiment, the method may further comprise:
simulating, by a classical computer, an execution of each selected auxiliary quantum circuit Aₐ to thereby obtain a noise-free auxiliary estimator value E_{O}(Aₐ, 0) associated with said selected auxiliary quantum circuit Aₐ;
defining a training data set, said training data set comprising for each of the selected auxiliary quantum circuits Aₐ the noise-free auxiliary estimator value E_{O}(Aₐ, 0) and the auxiliary estimator values E_{O}(Aₐ, Sᵢ) for the N execution strategies Sᵢ, i=1, . . . , N;
using the training data set to gain knowledge about the noise in the execution of the target quantum circuit by the quantum processor and to thereby derive an error mitigated value of the target estimator value E_{O}(T, 0) of the expectation value of the observable O.

As the auxiliary quantum circuits are all classically simulable, the simulation by the classical computer may be carried out efficiently.

In a case, where several selected auxiliary quantum circuits are used, it may be useful to use the already computed values vₐ of the figure of merit D to assign a coefficient to each auxiliary quantum circuit, so that their contribution to the technique may be assessed based on their ability to mimic the noise of the target quantum circuit. Thus, in a further embodiment, the method may further comprise assigning to each selected auxiliary quantum circuit Aₐ a real coefficient zₐ representative of a weight of a contribution of said selected auxiliary quantum circuit Aₐ in a set of training quantum circuits, wherein said coefficient zₐ is a function of the value vₐ of the figure of merit D for said selected auxiliary quantum circuit Aₐ, and wherein said training data set further comprises said real coefficient zₐ for each selected auxiliary quantum circuit Aₐ The coefficients zₐ act as a weight function for the auxiliary circuits Aₐ so that a circuit which yields a smaller dispersion contributes more in the error mitigation procedure. In short, the coefficients zₐ do not directly provide information about the noise, but rather they can make the error mitigation procedure to be more accurate.

According to a second aspect of the present invention, there is provided a computing system, said computing system comprising a classical computer and a quantum processor, wherein said computing system is configured to carry out the method according the first aspect of the present invention.

In particular, the classical computer may be configured to execute instructions to thereby perform steps iv) and v) of the method according to the present invention and the quantum processor may be configured to execute the quantum circuits according to the method of the present invention, in particular according to step iii). Selecting the execution strategies according to step ii) may assisted by a user input.

According to a third aspect of the present invention, there is provided a computer program product including instructions, which, when the program is executed by a computer system comprising a classical computer and a quantum processor, cause the computer system to carry out the method of the present invention.

According to a fourth aspect of the present invention, there is provided a computer-readable data carrier having stored thereon the computer program product according to the third aspect of the present invention.

In the following, the invention is described in more detail by way of example with reference to the figures, in which

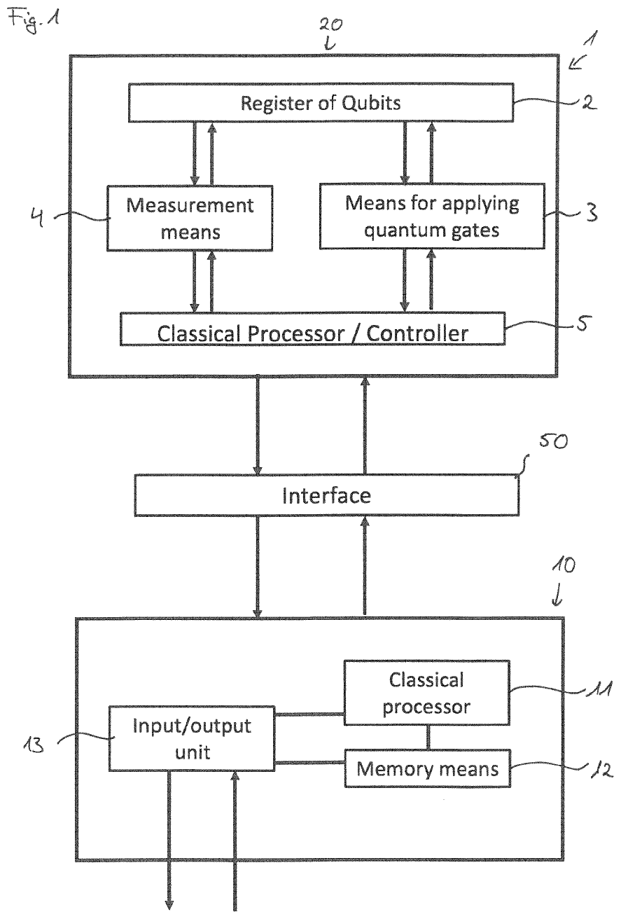

FIG. 1 depicts a schematic representation of a computing system according to the second aspect of the present invention,

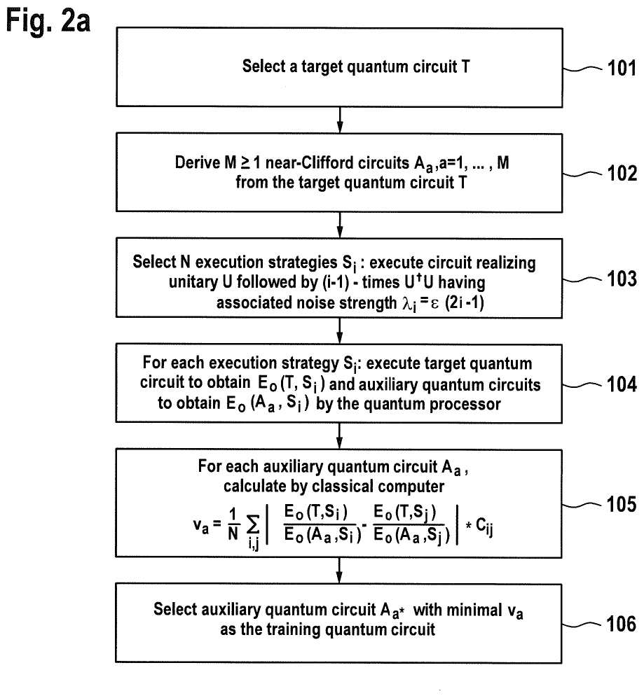

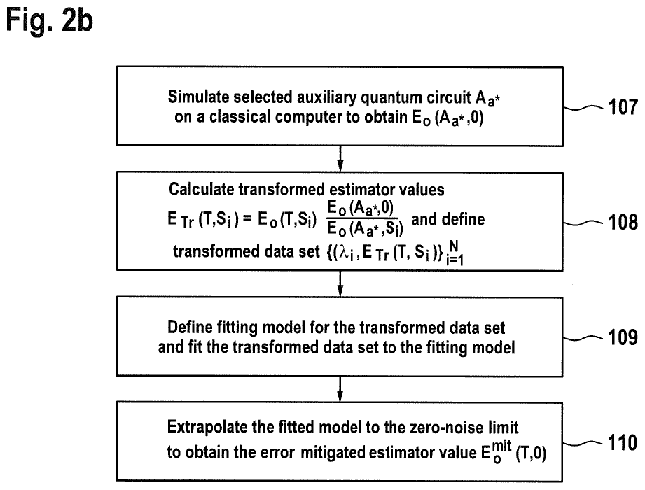

FIG. 2a depicts a flow chart of method steps of an embodiment of the method according to the first aspect of the present invention,

FIG. 2b depicts a flow chart of further method steps of the embodiment of the method depicted in FIG. 2a,

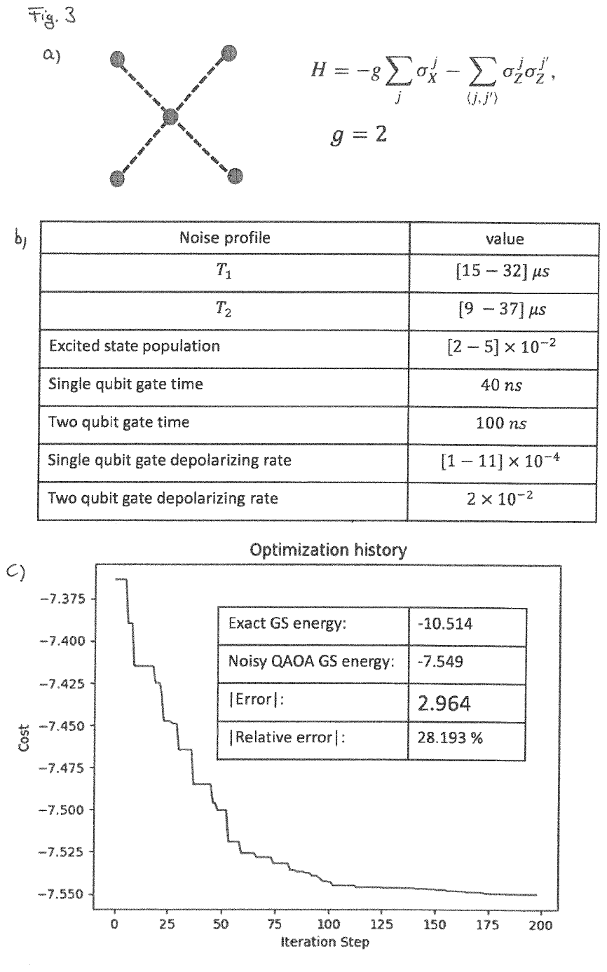

FIG. 3 depicts an example of a computational problem to which the method shown in FIGS. 2a and 2b is applied,

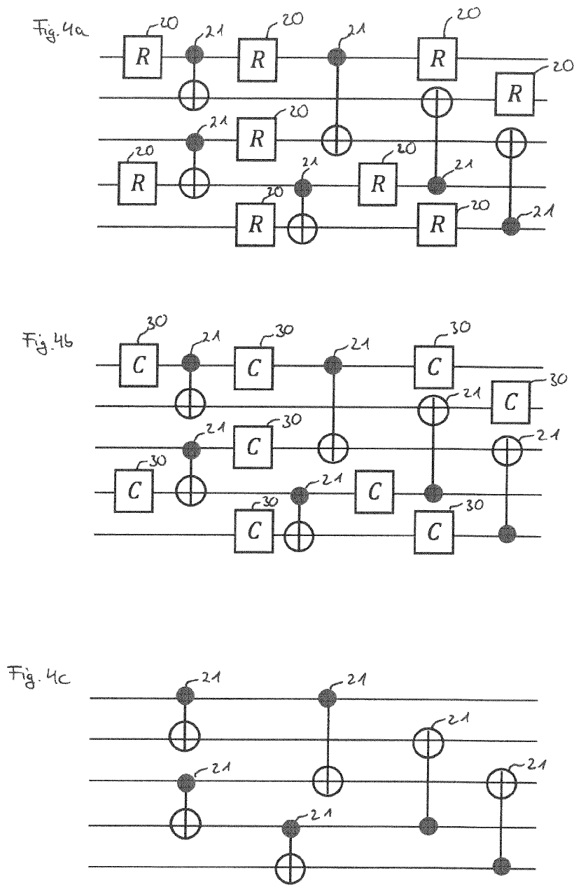

FIG. 4a depicts a schematic representation of a target quantum circuit T,

FIG. 4b depicts an example of an auxiliary quantum circuits derived from the target quantum circuit shown in FIG. 4a,

FIG. 4c depicts another example of an auxiliary quantum circuit derived from the target quantum circuit shown in FIG. 4a,

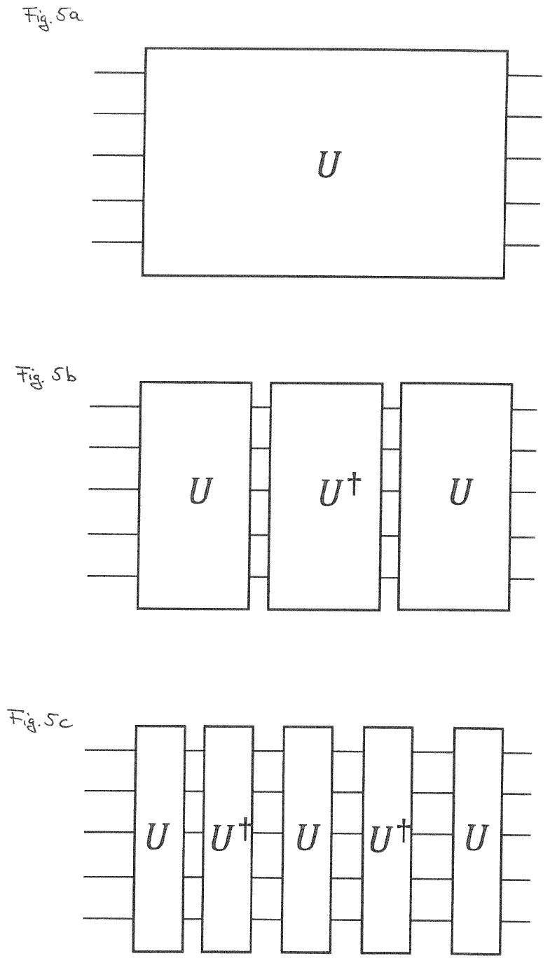

FIG. 5a depicts an execution strategy for a quantum circuit, e.g., the target or auxiliary quantum circuits shown in FIGS. 4a-4c,

FIG. 5b depicts another example of an execution strategy for a quantum circuit, e.g., the target or auxiliary quantum circuits shown in FIGS. 4a-4c,

FIG. 5c depicts yet another embodiment of an execution strategy for a quantum circuit, e.g., the target or auxiliary quantum circuits shown in FIGS. 4a-4c,

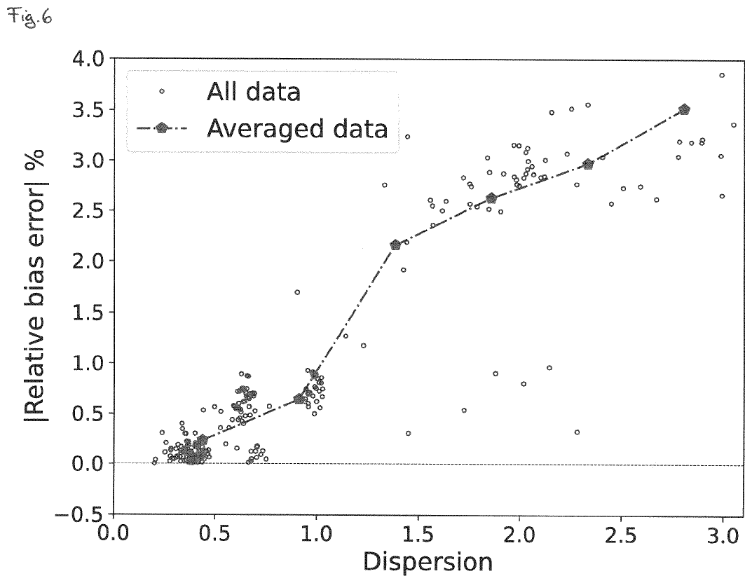

FIG. 6 depicts a plot showing the relation between the dispersion and the bias error for the computational problem shown in FIG. 3.

FIG. 1 depicts a schematic representation of a computing system 20 according to an aspect of the present invention. The computing system comprises a quantum processor 1 and a classical computer 10. Furthermore, the computing system 20 comprises an interface 50 interfacing the quantum processor 1 and the classical computer 10.

The classical computer 10 comprises a classical processor 11, memory means 12 and an input/output unit 13. The classical computer 10 is operative to receive instructions specifying the target quantum circuit T, the derivation of the at least one classically simulable auxiliary quantum circuit A_{α}, a=1, . . . , M and a plurality of execution strategies Sᵢ, i=1, . . . , N. The classical computer 10 may be operative to receive these instructions, for example, via a user input. The classical computer 10 may be further operative to derive the at least one auxiliary quantum circuit from the target quantum circuit in accordance with the received instructions and to transmit the instructions specifying the target quantum circuit T, the at least one derived auxiliary quantum circuit Aₐ, a=1, . . . , M and the plurality of execution strategies Sᵢ, i=1, . . . , N to the quantum processor 1 via the interface 50.

The quantum processor 1 comprises a register of qubits 2, means for applying quantum gates 3 and measurement means 4. Furthermore, the quantum processor 1 also comprises a classical processor/controller 5 for control of the means for applying quantum gates 3 and the measurement means 4.

The register of qubits may comprise n≥2 qubits. The type of qubits is not limited for the invention, and may comprise superconducting qubits, ion qubits, photonic qubits, atomic qubits, but is not limited to this. The means for applying quantum gates 3 is operative to apply quantum gates acting on a small number of qubits of the qubit register. For example, the means for applying quantum gates 3 may be operative to apply a sequence of single-qubit gates and two-qubit gates according to instructions specifying the quantum circuit and its execution strategy received from the controller 5. The measurement means 4 may be operative to perform single qubit measurements. In one example, the measurement basis may be determined by control of the controller. In one embodiment, the measurement may be performed in the computational basis.

The quantum processor 1 is further operative to receive, via the interface 50, instructions specifying the target quantum circuit T and the auxiliary quantum circuits Aₐ and the respective execution strategy. These instructions include instructions related to the initial state of the register of qubits, the sequence of single-qubit gates and two-qubit gates to be applied to the register of qubits and the observable O to be measured by the measurement means 4. Then, the quantum processor 1 may be operative, by control of the controller 5, to execute the quantum circuit as specified by the instructions. That is, the quantum processor 1 may be operative to prepare the register of qubits 2 in the initial state specified by the instructions, to apply a sequence of quantum gates by the mean for applying quantum gates 3, and to measure the value of the predetermined observable by the measurement means 4. The quantum circuit may be repeatedly executed by the quantum processor and the measurement outcomes for the observable O may be processed by the controller/classical processor 5 to thereby calculate an estimator value, respectively an auxiliary estimator value of the observable O. In one example, the respective estimator values may be the respective mean values obtained by measuring the value of the observable for the different shots. The quantum processor 1 may be further operative to transmit the determined estimator value, respectively auxiliary estimator value, via the interface 50 to the classical computer 10.

A computer program is stored on the memory means 12 of the classical computer 10. The computer program comprises instructions, which, when the program is executed by the classical computer 10, cause the computer to calculate for each auxiliary quantum circuit Aₐ a value vₐ of a figure of merit which is a function of at least the target estimator values and the auxiliary estimator values associated with said auxiliary quantum circuit Aₐ for each of the N execution strategies Sᵢ, wherein the figure of merit D is such that its value is minimal when the dependence of the target estimator values and the auxiliary estimator values on the execution strategies Sᵢ is similar, preferably, when it is identical.

In one example, the figure of merit is of the following form:

$$D ( {A}_{a} ) = {\sum }_{i \neq j = 1}^{N} {C}_{i j} * \vert {E}_{O} ( T , {S}_{i} ) / {E}_{O} ( {A}_{a} , {S}_{i} ) - {E}_{O} ( T , {S}_{j} ) / {E}_{O} ( {A}_{a} , {S}_{j} ) \vert ,$$

where Cᵢⱼ are real numbers, and vₐ=D(Aₐ). Preferably, the Cᵢⱼ are chosen as

$${C}_{i j} = C = \frac{{E}_{O} ( {A}_{a} , 0 )}{N} .$$

Here the nominator is the noise-free expectation value of the observable O associated with the auxiliary circuit Aₐ. It may be assumed that this is not zero. I.e., if this turns out to be zero, one may discard that specific auxiliary quantum circuit and select another auxiliary quantum circuit. The denominator is the number of execution strategies, N.

The computer program comprises further instructions, which, when the program is executed by the classical computer 10, cause the classical computer 10 to select 1≤k≤M auxiliary quantum circuits Aₐ for which the value vₐ of the figure of merit D fulfills a validation criterion as the training quantum circuits for the learning-based error mitigation method. In one example, the validation criterion is fulfilled, when vₐ is at most a validation threshold value, wherein the validation threshold value is one of the values vₐ of the figure of merit D. In one example, the validation threshold value is the smallest value vₐ of the M values of the figure of merit D. Then, only one auxiliary quantum circuit, namely the auxiliary quantum circuit which mimics best the noise present in the execution of the target quantum circuit is selected as the training quantum circuit.

The computer program may further comprise instructions which, when the computer program is executed by the classical computer 10, cause the computer to output information specifying the selected auxiliary quantum circuits. Additionally, or alternatively, the selected auxiliary quantum circuits may be used by the classical computer 10 for a learning-based error mitigation technique to thereby obtain an error mitigated estimator value of the expectation value of the observable O for the target quantum circuit.

FIG. 2a depicts a flow chart of method steps of an embodiment of the method according to the first aspect of the present invention. The method starts at 101 with the selection of a target quantum circuit by a user of the method. The target quantum circuit may be related to the solution of a specific computational problem. An example of such a computational problem is shown in FIG. 3. FIG. 3a schematically depicts five qubits (solid circles) which interact (dashed lines) by a transverse Ising Hamiltonian H with coupling strength g=2. The explicit form of the Hamiltonian is shown in FIG. 3a.

$${σ}_{X}^{j}$$

is the Pauli X-matrix acting on the qubit j, and

$${σ}_{Z}^{j} {σ}_{Z}^{{j}^{′}}$$

is a coupling term between nearest neighbor qubits j and j′ as indicated by the dashed lines in FIG. 3a. The computational problem is to find the ground state energy of said model on a quantum processor 1. To this end, a QAOA (Quantum Approximate Optimization Algorithm)-type target quantum circuit is used to find the ground state energy of the transverse Ising model. The target quantum circuit comprises a target gate sequence comprising single-qubit rotations around the X, Y and Z axis and controlled-Z operations. The noise profile of the quantum processor is summarized in FIG. 3b.

FIG. 3c shows the optimization history for the ground state energy. A comparison of the noisy QAOA ground state energy with the exact ground state energy reveals that the relative error in the energy is around 30%.

Returning to FIG. 2a, at step 102, M=400 near Clifford circuits Aₐ, a=1, . . . , 400 are derived from the target quantum circuit T. To this end, at least one non-Clifford gate of the target gate sequence of the target quantum circuit T is replaced by a Clifford gate or is removed without a replacement to thereby obtain the respective auxiliary gate sequence.

FIGS. 4b and 4c depict examples of auxiliary quantum circuits derived from the target quantum circuit shown in FIG. 4a. FIG. 4a is a schematic representation of the target gate sequence of the target quantum circuit T, for example, the target quantum circuit for the computational problem shown in FIG. 3. FIG. 4a shows a target gate sequence wherein a sequence of single-qubit gates R (ref. 20) and two-qubit gates 21 is applied to five qubits. In general, the single-qubit gates are different for different qubits. The single-qubit gates 20 may be rotations around the X, Y and Z axes. In the target gate sequence shown in FIG. 4a, it is assumed that all single-qubit gates are non-Clifford gates. The two-qubit gates 21 may be controlled Z-gates or controlled-NOT gates. The auxiliary gate sequence of the auxiliary quantum circuit shown in FIG. 4b is derived by replacing all non-Clifford gates in the target gate sequence shown in FIG. 4a by the closest Clifford gate (C) 30. The auxiliary gate sequence of the auxiliary quantum circuit shown in FIG. 4c is derived from the target gate sequence shown in FIG. 4a by removing all single qubit gates without a replacement.

At S103, the method proceeds with selecting N execution strategies S₁. In the example, the execution strategies are selected as shown in FIGS. 5a-5c. If the complete gate sequence of the target or auxiliary quantum circuits is represented as a unitary U (see FIG. 5a), the execution strategy Sᵢ is executing the circuit realizing the unitary U followed by executing (i−1)—times the gate sequence represented by U^{†}U. That is, the execution strategy S₁ is executing the target or auxiliary gate sequence realizing the unitary U, the execution strategy S₂ is realizing the unitary U followed by U^{†}U. If the execution strategy S₁ has a value λ=1 of the noise strength, the execution strategy S₂ (see FIG. 5b) has the associated value λ₂=3 of the noise strength λ. The execution strategy S₃ (see FIG. 5c) is realizing the unitary U followed by 2 times the gate sequence represented by U^{†}U. That is, in total the unitary UU^{†}UU^{†}U is realized. The execution strategy S₃ has the associated value λ₃=5 of the noise strength λ.

Then, the method proceeds at 104 with executing, for each execution strategy Sᵢ the target quantum circuit to obtain the target estimator value E_{O} (T, Sᵢ) and to execute the auxiliary quantum circuit to obtain the auxiliary estimator value E_{O} (Aₐ, Sᵢ) by the quantum processor. The obtained estimator values and auxiliary estimator values are then provided to a classical computer. There, the classical computer computes for each auxiliary quantum circuit Aₐ the value

$${v}_{a} = \frac{1}{N} {\sum }_{i j} \vert \frac{{E}_{O} ( T , {S}_{i} )}{{E}_{O} ( {A}_{a} , {S}_{i} )} - \frac{{E}_{O} ( T , {S}_{j} )}{{E}_{O} ( {A}_{a} , {S}_{j} )} \vert {C}_{i j} ,$$

of a figure of merit D, wherein Cᵢⱼ are real coefficients. In particular,

$${C}_{i j} = C = \frac{{E}_{O} ( {A}_{a} , 0 )}{N} .$$

Here the nominator is the noise-free expectation value of the observable O associated with the auxiliary circuit Aₐ. It may be assumed that this is not zero. I.e., if this turns out to be zero, one may discard that specific auxiliary quantum circuit and select another auxiliary quantum circuit. The denominator is the number of execution strategies, N. The associated figure of merit D has the property that it is minimal when the dependence of the target estimator values and the auxiliary estimator values on the execution strategies Sᵢ is identical, i.e. when

$$\frac{{E}_{O} ( T , {S}_{i} )}{{E}_{O} ( {A}_{a} , {S}_{i} )} = r ,$$

for all E_{O}(Aₐ,Sᵢ) execution strategies Sᵢ, with real r.

At 106, the auxiliary quantum circuit Aₐ, a→a* with minimal value vₐ is selected as the training quantum circuit for the learning-based error mitigation technique.

FIG. 2b depicts a flow chart of further method steps for the embodiment of the method depicted in FIG. 2a. In particular, the method comprises at 107 simulating the selected auxiliary quantum circuit A_{a*} on a classical computer to obtain the noise-free auxiliary estimator value E_{O} (A_{a*}, 0). Then, at 108, transformed estimator values

$${E}_{T r} ( T , {S}_{i} ) = {E}_{O} ( T , {S}_{i} ) \frac{{E}_{O} ( {A}_{a} * , O )}{{E}_{O} ( {A}_{a} * , {S}_{i} )}$$

are calculated, and a transformed data set

$${\{ ( {λ}_{i} , {E}_{T r} ( T , {S}_{i} ) \}}_{i = 1}^{N}$$

is defined. This data set has a reduced dispersion compared to the original data set

$${\{ ( {λ}_{i} , {E}_{O} ( T , {S}_{i} ) \}}_{i = 1}^{N} .$$

Finally, at 109, a fitting model for the transformed data set is defined. The transformed data set is fitted to the fitting model. The fitting model could be a fitting function of a parametric family of functions. Then, at 110, the fitted model is extrapolated to the zero-noise limit to obtain the error mitigated estimator value E_{O}^{mit}(T, 0).

FIG. 6 shows how the relative bias error of the ground state energy (in percent) (y-axis) for the example shown in FIG. 3 depends on the value vₐ of the dispersion (x-axis). Here, zero-noise extrapolation (for the transformed data) is used as the error mitigation technique. As one may take from the plot shown in FIG. 6, the smaller the dispersion, the smaller the relative bias error. In this way, a bias error of less than 0.2 percent could be obtained. This leads to a significant improvement of the accuracy of the ground state energy.

1. A method for mitigating errors caused by noise in an execution of a target quantum circuit T by a quantum processor, said method being a learning-based method using at least one training quantum circuit to gain knowledge about the noise in the execution of the target quantum circuit by the quantum processor, said method comprising:
deriving at least one auxiliary quantum circuit Aₐ, a=1, . . . , M, M≥1 from said target quantum circuit T, wherein each auxiliary quantum circuit is efficiently classically simulable;
selecting a plurality of N execution strategies Sᵢ, i=1, . . . , N for the quantum circuits, each execution strategy corresponding to an execution of the quantum circuit with an associated value λᵢ≥1 of a noise strength λ;
for each execution strategy Sᵢ, executing the target quantum circuit and each of the M auxiliary quantum circuits Aₐ on the quantum processor according to said execution strategy Sᵢ to thereby obtain a target estimator value E_{O}(T, Sᵢ) of an expectation value of an observable O, said target estimator value E_{O}(T, Sᵢ) being associated with the target quantum circuit T and the execution strategy Sᵢ, and an auxiliary estimator value E_{O}(Aₐ, Sᵢ) of the expectation value of the observable O, said auxiliary estimator value E_{O}(Aₐ, Sᵢ) being associated with the auxiliary quantum circuit Aₐ and the execution strategy Sᵢ;
for each auxiliary quantum circuit Aₐ, calculating, by a classical computer, a value vₐ of a figure of merit D which is a function of at least the target estimator values E_{O}(T, Sᵢ) and the auxiliary estimator values E_{O}(Aₐ, Sᵢ) associated with said auxiliary quantum circuit Aₐ for each of the N execution strategies Sᵢ, i=1, . . . , N, wherein the figure of merit D is such that its value is minimal when the dependence of the target estimator values E_{O}(T, Sᵢ) and the auxiliary estimator values E_{O}(Aₐ, Sᵢ) on the execution strategies Sᵢ is similar;
selecting 1≤k≤M auxiliary quantum circuits Aₐ for which the value vₐ of the figure of merit D fulfills a validation criterion as the training quantum circuits for the learning-based error mitigation method.

2. The method of claim 1, wherein the value vₐ fulfills the validation criterion when vₐ is at most a validation threshold value, the validation threshold value being preferably one of the values vₐ of the figure of merit D for the M auxiliary quantum circuits.

3. The method of claim 2, wherein the validation threshold value is the smallest value vₐ of the M values of the figure of merit D.

4. The method of claim 3, wherein for each auxiliary quantum circuit Aₐ, the figure of merit D is proportional to a measure of dispersion of the ratios of the target estimator values E_{O}(T, Sᵢ) and the auxiliary estimator values E_{O}(Aₐ, Sᵢ) for each execution strategy Sᵢ, D (Aₐ)=D(E_{O}(T, S₁)/E_{O}(Aₐ, S₁), . . . , E_{O}(T, S_{N})/E_{O}(Aₐ, S_{N})).

5. The method of claim 4, wherein for each auxiliary quantum circuit Aₐ, the figure of merit D is a function of the absolute values of the differences between the ratios of the target estimator values E_{O}(T, Sᵢ), E_{O}(T, Sⱼ) and the auxiliary estimator values E_{O}(Aₐ, Sᵢ), E_{O}(Aₐ, Sⱼ) for pairwise different execution strategies Sᵢ, Sⱼ, and preferably
$$D ( {A}_{a} ) ∝ {\sum }_{i \neq j = 1}^{N} {C}_{i j} \vert {E}_{O} ( T , {S}_{i} ) / {E}_{O} ( {A}_{a} , {S}_{i} ) - {E}_{O} ( T , {S}_{j} ) / {E}_{O} ( {A}_{a} , {S}_{j} ) \vert ,$$
wherein Cᵢⱼ are real numbers.

6. The method of claim 5, wherein said target quantum circuit T comprises a target gate sequence with a first quantum gate, said first quantum gate acting on at least one qubit, and wherein deriving at least one of said auxiliary circuits Aₐ from said target quantum circuit T comprises replacing said first quantum gate by a replacement gate thereby obtaining an auxiliary gate sequence, said replacement gate acting preferably on the same qubits as the first quantum gate.

7. The method of claim 6, wherein said first quantum gate comprises a non-Clifford gate, and said replacement gate comprises a Clifford gate.

8. The method of claim 7, wherein said replacement gate is a Clifford gate which is the closest Clifford gate to said first quantum gate or wherein an angle of said Clifford gate is randomly selected.

9. The method of claim 8, wherein said target gate sequence comprises a plurality of non-Clifford gates, and wherein deriving at least one of said auxiliary quantum circuits from the target quantum circuit comprises replacing each non-Clifford gate of a first number of the non-Clifford gates by a Clifford gate and keeping each non-Clifford gate of a second number of the non-Clifford gates.

10. The method of claim 6, wherein the target gate sequence comprises a third quantum gate and deriving of at least one of said auxiliary quantum circuits Aₐ from said target quantum circuit T comprises removing the third quantum gate.

11. The method of claim 6, wherein a first execution strategy Sᵢ associated with a first value λᵢ of the noise strength λ comprises an implementation of a second quantum gate of said gate sequence by an application of a control pulse C during an application time r by said quantum processor, and wherein a second execution strategy associated with a second value λⱼ of the noise strength λ which is larger than the first noise strength, λⱼ>λ, comprises an implementation of the second quantum gate by an application of a recalibrated control pulse C′ for a stretched application time τ′=τ·λⱼ/λᵢ by said quantum processor.

12. The method of claim 6, wherein a third execution strategy comprises adding an additional gate sequence corresponding to an identity operation to said gate sequence of said quantum circuit, wherein preferably the additional gate sequence corresponds to a product of a unitary operation Uᵢ and its hermitian conjugate
$${U}_{i}^{†} ,$$
wherein the unitary operation or its hermitian conjugate corresponds to at least one gate of said gate sequence of said quantum circuit.

13. The method of claim 6, wherein a fourth execution strategy comprises executing said gate sequence of said quantum circuit followed by executing the inverse of said gate sequence.

14. The method of claim 1, wherein said method further comprises:
simulating, by a classical computer, an execution of each selected auxiliary quantum circuit Aₐ to thereby obtain a noise-free auxiliary estimator value E_{O}(Aₐ, 0) associated with said selected auxiliary quantum circuit Aₐ;
defining a training data set, said training data set comprising for each of the selected auxiliary quantum circuits Aₐ the noise-free auxiliary estimator value E_{O}(Aₐ, 0) and the auxiliary estimator values E_{O}(Aₐ, Sᵢ) for the N execution strategies Sᵢ, i=1, . . . , N;
using the training data set to gain knowledge about the noise in the execution of the target quantum circuit by the quantum processor and to thereby derive an error mitigated value of the target estimator value E_{O}(T, 0) of the expectation value of the observable O.

15. The method of claim 14, wherein said method further comprises assigning to each selected auxiliary quantum circuit Aₐ a real coefficient zₐ representative of a weight of a contribution of said selected auxiliary quantum circuit Aₐ in the target quantum circuit, wherein said coefficient zₐ is a function of the value vₐ of the figure of merit D for said selected auxiliary quantum circuit Aₐ, and wherein said training data set further comprises said real coefficient zₐ for each selected auxiliary quantum circuit Aₐ.

16. A computing system, said computing system comprising a classical computer and a quantum processor, wherein said computing system is configured to carry out the method according to claim 1.

17. A computer program product including instructions which, when the program is executed by a computer system comprising a classical computer and a quantum processor, cause the computer system to carry out the method of claim 1.

18. A computer-readable data carrier having stored thereon the computer program product of claim 17.
